(19) United States
(12) Patent Application Publication
(10) Pub. No.: US 2026/0322890 A1
(43) Pub. Date: Oct. 15, 2026

(54) GENERATIVE ARTIFICIAL INTELLIGENCE EXTRACTION AND REFINEMENT OF A USER PROFILE

(71) Applicant: SAP SE, Walldorf (DE)

(72) Inventors: Oliver SCHIRMER, Heidelberg (DE); Frank FEINBUBE, Potsdam (DE)

(21) Appl. No.: 19/179,185

(22) Filed: Apr. 15, 2025

(51) Int. Cl. H04L 67/306

(52) U.S. Cl. CPC H04L 67/306

(57) ABSTRACT

An interaction data store contains electronic records to represent real-world interaction data associated with a user, and an analysis data store contains insights about the user. An extended reality framework collects, from the interaction data store, information about real-world interactions with the user and integrates that information with real-world environment data. The framework may then process the real-world interactions and real-world environment data using multi-modal data fusion techniques, real-time data enrichment, and contextual data mapping to link the real-world interactions with a real-world scenario. Augmented analytics are performed to generate enhanced insights about the user, and the analysis data store is updated with the enhanced insights. An immersive extended reality visualization can then be created based on the enhanced insights. According to some embodiments, at least some of the augmented analytics are done by a set of LLM agents that work together.

### BACKGROUND

An enterprise may want to create an “extended reality” (e.g., a three-dimensional interactive environment) for a number of reasons. As used herein, the phrase “extended reality” (or “XR”) might refer to Virtual Reality (“VR”), Augmented Reality (“AR”), Mixed Reality (“MR”), etc. environments that combine or mirror the physical world with a “digital twin world” giving users an immersive experience by being in and interacting with a simulated environment. This technology may provide customers with the insight to help avoid design mistakes and reinvent how businesses are run. Business data can be connected or “augmented” to the physical world, such as a building, an assembly line in a factory, or a machine providing services in the field. Service operations and work instructions might be better understood and executed by the user, saving time and increasing product quality. For example, a business may create an extended reality environment to train or evaluate employees. Moreover, the enterprise may want to leverage extended reality technology to create a near-perfect digital twin of human behavior and interactions. Similarly, the enterprise may attempt to use extended reality derived data to revolutionize analytics across multiple domains and combine extended reality data with other data sources for enhanced insights. In addition, the enterprise may want to apply extended reality analytics to multiple fields such as healthcare, education, urban planning, etc. Manually achieving these goals, however, is a time consuming, error prone, and expensive task for developers.

Moreover, current approaches lack an efficient and consistent way to customize and refine the output of Generative Artificial Intelligence (“GenAI”) models, such as Large Language Models (“LLMs”), across different use cases and sessions. Currently, the customization of these models is a labor-intensive process that involves a significant amount of manual definition. This process often involves trial-and-error and deducing from the outputs what is unpleasurable, which then leads to defining what is actually desired. The resulting definitions do not generalize well across different use cases and are not persisted across sessions (leading to inefficiencies and inconsistencies).

Furthermore, the problem extends to both general and use case specific preferences. General preferences may include the choice of language, accessibility considerations such as a color blind mode, and emotional preferences such as the tone of conversation or image. Use case specific preferences may include factual preferences such as the desire for brief answers or a preference for a certain genre or style, like western versus science fiction. The current methods for defining these preferences are not only laborious but also lack the ability to effectively capture and apply these preferences across different use cases and sessions.

It would therefore be desirable to provide an improved extended reality framework in a secure, automatic, and efficient manner. Moreover, the framework may be flexible, scalable, robust, extensible, etc. It may be desirable to improve and/or personalize GenAI interactions (from casual day-to-day interactions to business/domain-specific like analytics) by leveraging additional data points provided by XR-interactions, harnessing their implied information about the user and context, and running automated and/or advanced analytics on such a rich ground truth.

### SUMMARY

According to some embodiments, methods and systems include an interaction data store that contains electronic records to represent real-world interaction data associated with a user (and in some cases, XR interaction data and/or real-world non interactive data, such as a user heart rate from a wearable device), and an analysis data store contains insights about the user. An extended reality framework collects, from the interaction data store, information about real-world interactions with the user and integrates that information with real-world environment data. The framework may then process the real-world interactions and real-world environment data using multi-modal data fusion techniques, real-time data enrichment, and contextual data mapping to link the real-world interactions with a real-world scenario. Augmented analytics are performed to generate enhanced insights about the user, and the analysis data store is updated with the enhanced insights. An immersive extended reality visualization can then be created based on the enhanced insights. According to some embodiments, at least some of the augmented analytics are done by a set of LLM agents that work together. According to some embodiments, actual data processing (e.g., enrichment and analytics) can be performed without any XR involvement, but instead via additional scripts, pipelines, automated tasks, etc. (e.g., only data collection and visualization/interaction might be facilitated using XR).

Some embodiments comprise: means for collecting, by a computer processor of an extended reality framework, information about real-world interactions with a user from an interaction data store that contains electronic records to represent real-world interaction data associated with the user; means for integrating the information about real-world interactions with real-world environment data; means for processing the information about the real-world interactions and real-world environment data using multi-modal data fusion techniques, real time data enrichment, and contextual data mapping to link the real-world interactions with a real-world scenario; means for performing augmented analytics to generate enhanced insights about the user; means for updating an analysis data store with the enhanced insights about the user; and means for creating an immersive extended reality visualization based on the enhanced insights.

According to some embodiments, methods and systems associated with an extended reality framework collect information about real-world interactions with a user. The collected information is processed using an optimized profile detail prompt and a first GenAI model to create new profile details. The new profile details are then processed using one or more AI processing methods to update a user profile data store. The AI processing methods might include, for example, an optimized profile consolidation prompt and a second GenAI model (prompt chaining), workflow patterns (e.g., orchestrator-worker, evaluator-optimizer, router, etc.), agent patterns (e.g., network, hierarchical, etc.), or other traditional algorithm-based approaches. The system can then automatically infuse information from the user profile data store into new prompts from the user to make another GenAI model aware of user preferences.

Some embodiments comprise: means for collecting, by an extended reality framework computer processor, information about real-world interactions with a user; means for processing the collected information using an optimized profile detail prompt and a first GenAI model to create new profile details; and means for processing the new profile details using one or more AI processing methods to update a user profile data store that contains electronic records to represent user preference information associated with a user; and means for automatically infusing information in the user profile data store into new prompts from the user to make another GenAI model aware of user preferences.

According to some embodiments, methods and systems associated with an extended reality framework collect information about real-world interactions with a user. The framework then performs an interaction-response reaction analysis of the real-world interactions (or any other analytics technique which is not focused on interaction-response pairs) and updates the user profile data store with a result of the interaction-response reaction analysis. The system may then perform profile detail curation based on user interactions and information in the user profile data store to generate relevant profile details. A GenAI model processes the relevant profile details and user interactions to create a personized result for the user.

Some embodiments comprise: means for collecting, from an interaction data store, information about real-world interactions with a user; means for performing an interaction-response reaction analysis of the real-world interactions (or any other analytics technique which is not focused on interaction-response pairs); means for performing; means for updating the user profile data store with a result of the interaction-response reaction analysis; means for performing profile detail curation based on user interactions and information in the user profile data store to generate relevant profile details; means for processing, via a GenAI model, the relevant profile details and user interactions to create a personized result for the user.

Some technical advantages of some embodiments disclosed herein are improved systems and methods to provide an extended reality framework in a secure, automatic, and efficient manner. Moreover, embodiments may be flexible, scalable, robust, extensible, etc.

### BRIEF DESCRIPTION OF THE DRAWINGS

FIG. 1 is a high-level extended reality framework architecture in accordance with some embodiments.

FIG. 2 is a method according to some embodiments.

FIG. 3 is a more detailed system according to some embodiments.

FIG. 4 is an agentic extended reality system in accordance with some embodiments.

FIG. 5 is an immersive environment in accordance with some embodiments.

FIGS. 6A and 6B show a system and method according to some embodiments.

FIGS. 7A and 7B show a system and method in accordance with some embodiments.

FIG. 8 is a more detailed version of the system of FIG. 6A according to some embodiments.

FIG. 9 is a more detailed version of the system of FIG. 7A in accordance with some embodiments.

FIG. 10 illustrates some examples of use cases according to some embodiments.

FIG. 11 is an apparatus or platform according to some embodiments.

FIG. 12 is a portion of an extended reality database in accordance with some embodiments.

FIG. 13 illustrates a tablet computer extended reality display according to some embodiments.

FIG. 14 is an extended reality framework operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

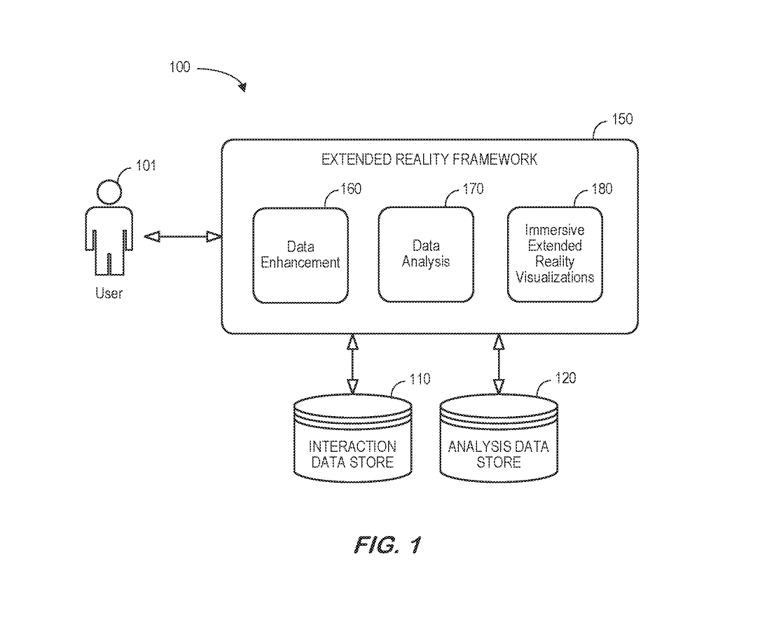

FIG. 1 is a high-level block diagram of one example of an extended reality framework architecture 100 according to some embodiments. In particular, an extended reality framework 150 may exchange information associated with extended reality with an interaction data store 110 and an analysis data store 120. The extended reality framework 150 may use data enhancement 160, data analysis 170, and/or immersive extended reality visualizations 180 to create or modify an immersive experience in response to a request from a user 101. According to some embodiments, a remote operator or administrator device may be used to configure or otherwise adjust the architecture 100.

As used herein, devices, including those associated with the architecture 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The extended reality framework 150 may store information into and/or retrieve information from various data stores (e.g., the interaction data store 110), which may be locally stored or reside remote from the extended reality framework 150. Although a single extended reality framework 150 is shown in FIG. 1, any number of such devices may be included. Moreover, various devices described herein might be combined according to embodiments of the present invention. For example, in some embodiments, the interaction data store 110 and the extended reality framework 150 might comprise a single apparatus. The framework 150 functions may be performed by a constellation of networked apparatuses, such as in a distributed processing or cloud-based architecture. In some cases, the extended reality framework 150 may process information associated with a number of different enterprises.

An enterprise may access the framework 150 via a remote device (e.g., a Personal Computer (“PC”), tablet, or smartphone) to view information about and/or manage operational information in accordance with any of the embodiments described herein. In some cases, an interactive Graphical User Interface (“GUI”) display may let an operator or administrator define and/or adjust certain parameters via a remote device (e.g., to specify how the framework 150 connects with an enterprise computing environment infrastructure, to edit scenes, etc.) and/or provide or receive automatically generated recommendations, alerts, summaries, or results associated with the framework 150.

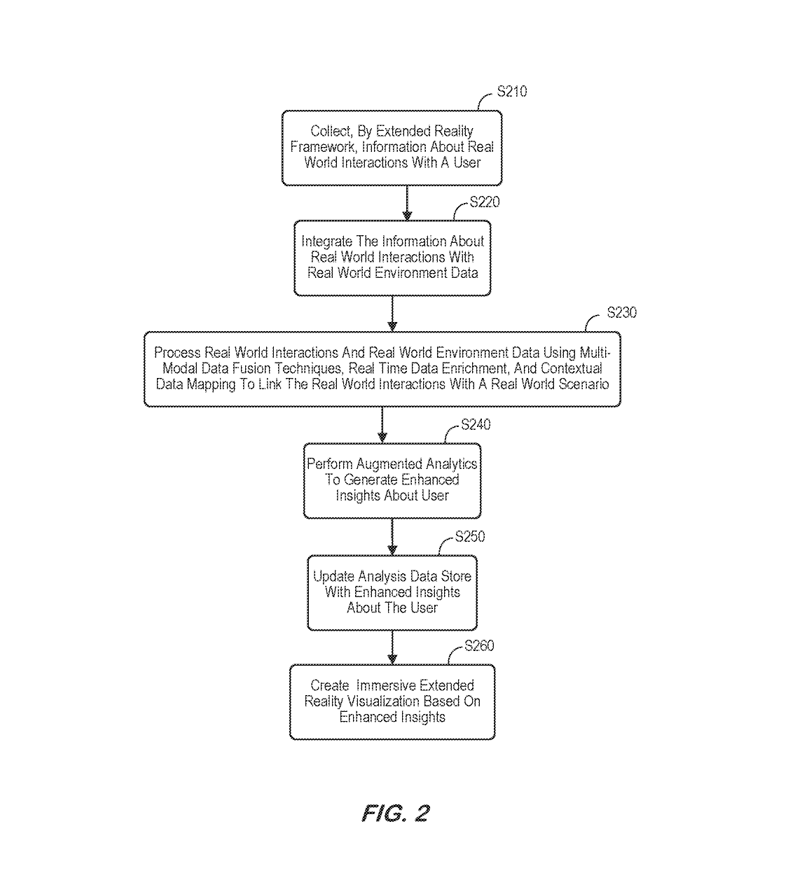

FIG. 2 is a method that might be performed by some or all of the elements of the framework 150 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, the system may collect information about real-world interactions with a user from an interaction data store that contains electronic records to represent real-world interaction data associated with the user. The interactions might be associated with, for example, text/voice-based interactions, embodied/extended reality-based interactions, biometric sensor data, neurological sensor data, environmental sensor data, context metadata, etc.

Moreover, this information might be enhanced via multimodal data fusion, cognitive load estimation, emotion inference, etc. The information may represent, for example, structured and/or unstructured data, such as raw, high-volume extended reality data from a data lake. At S220, the information about real-world interactions is integrated with real-world environment data. In some embodiments, the collection of information about real-world interactions with the user includes biometric data (e.g., heart rate, pupil dilation, and skin conductance), neurological data (e.g., electroencephalogram (“EEG”) patterns using neural interfaces), kinesthetic data (e.g., full-body motion capture and micro-expressions), auditory data (e.g., voice tone, pace, and volume), environmental data (e.g., a user’s interaction with virtual objects and spaces), text and voice interactions, and/or context metadata.

At S230, the information about the real-world interactions and real-world environment data is processed using multi-modal data fusion techniques, real time data enrichment, and contextual data mapping to link the real-world interactions with a real-world scenario. The integration of real-world interactions with real-world data might be associated with Internet of Things (“IoT”) sensors for physical environment data, wearable sensors for continuous biometric monitoring, etc.

At S240, augmented analytics are performed to generate enhanced insights about the user. The augmented analytics might include, for example, a predictive modeling pipeline, cognitive mapping, social network analysis, clustering, classification regression, a time series analysis, anomaly detection, etc. The augmented analytics might include, for example,) behavioral pattern recognition, predictive modeling of human decision-making processes, cognitive mapping and mental model extraction, social network analysis within extended reality environments, anomaly detection in behavior and physiological responses, etc.

At S250, an analysis data store is updated with the enhanced insights about the user. Information in the analysis data store might include, for example, behavioral patterns, cognitive maps, predictive models, social network graphs, time series data, anomaly reports, performance metrics, comparative analytics, text/voice interactions, embodied/extended reality interactions, context metadata, etc. Note that the augmented analytics may include behavioral pattern recognition, predictive modeling of human decision-making processes, cognitive mapping and mental model extraction, social network analysis within extended reality environments, anomaly detection in behavior and physiological responses, etc.

At S260, an immersive extended reality visualization is created based on the enhanced insights. In some embodiments, the extended reality framework may also perform visualizations for analysts, interactions for analysts, interactive scenario modelling, a “what-if” analysis, etc. In other embodiments, the extended reality framework further performs anonymization techniques for sensitive behavioral data and/or user-controlled data sharing and analysis permissions for ethical and privacy considerations.

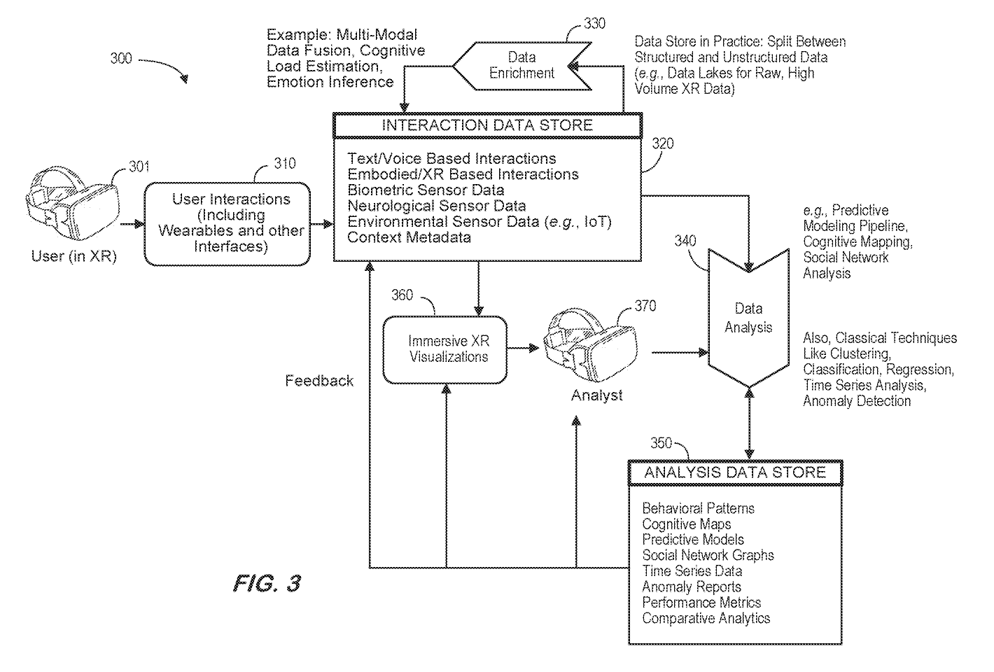

FIG. 3 is a more detailed system 300 according to some embodiments. A user 301 in extended reality may interact 310 with the system. That information may be stored in an interaction data store 320 and be periodically enriched 330. Information in the interaction data store 320 may undergo data analysis 340, and the results may be stored in an analysis data store 350. The information in the analysis data store 350 can then be used (along with interaction data) to create immersive extended reality visualizations 360. The information in the analysis data store 350 might also be used as feedback and/or be sent to an analyst 370 who may update the data analysis 340 based on the results.

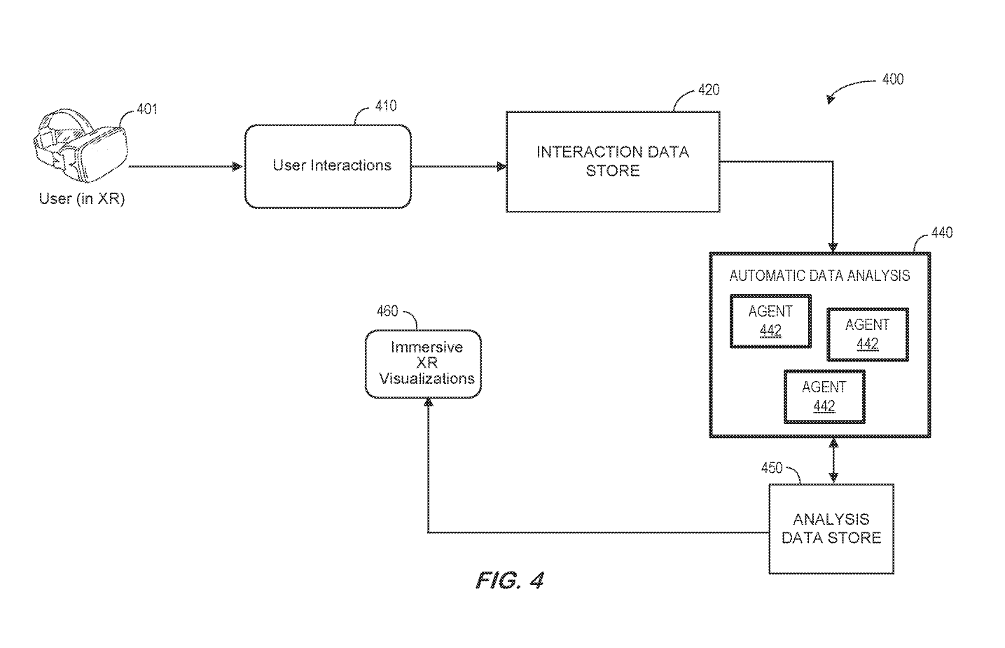

According to some embodiments, at least some of the augmented analytics are associated with Artificial Intelligence (“AI”) techniques, such as an LLM. In other embodiments, the AI techniques include a set of AI agents that work together. FIG. 4 is an agentic extended reality system 400 in accordance with some embodiments. As before, a user 401 in extended reality may interact 310 with the system. That information may be stored in an interaction data store 420 and undergo data analysis 440, and the results may be stored in an analysis data store 450. The information in the analysis data store 450 can then be used to create immersive extended reality visualizations 460. In this embodiment, the automatic data analysis 440 is performed by a team of AI agents 442, such as LLM powered AI agents 442 that have complex reasoning capabilities, memory, and the means to execute tasks to reason through a problem, create a plan to solve the problem, execute the plan, etc. Note that many different types of data sources might be consulted by the AI agents 442, such as business guidelines, enterprise goals, advertisements, employee training materials, etc. The AI agents 442 (such as SAP™ Joule® agents) may understand business context and collaborate across functions – connecting departments, accelerating decisions, and streamlining processes so work gets done faster. The AI agents 442 may execute complex workflows with precision to understand data and processes and act reliably through business applications.

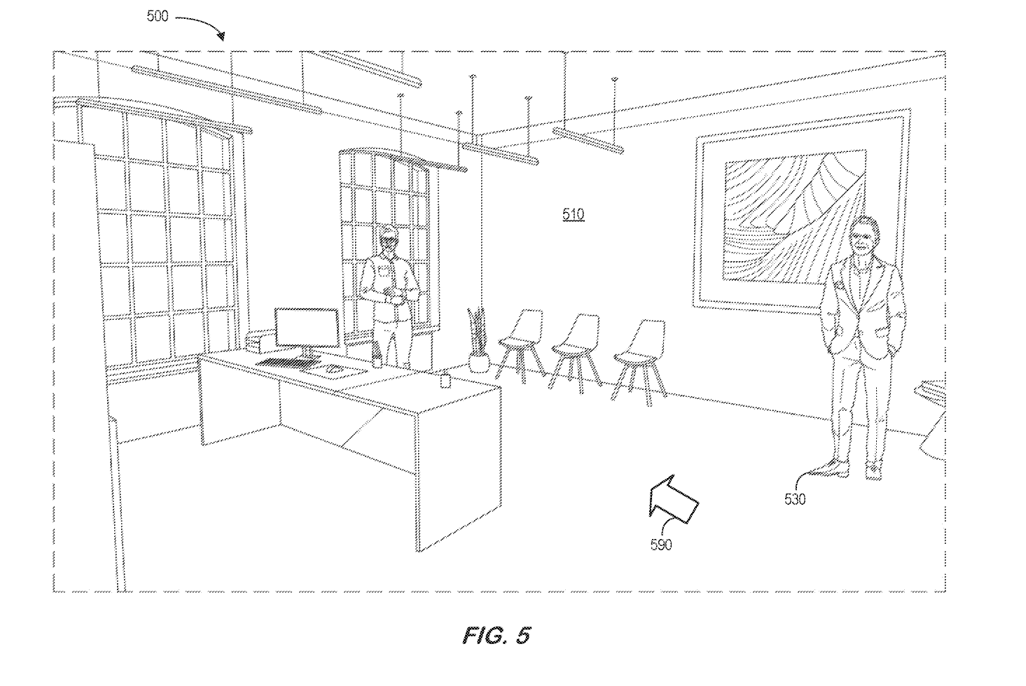

FIG. 5 is an extended reality immersive environment 500 in accordance with some embodiments. The environment 500 might include a three-dimensional room 510 with furniture and virtual agents or characters 530 that a user can interact with (e.g., via voice, eye movement, a touchscreen or computer mouse pointer 590, etc.). According to some embodiments, extended reality augmented analytics may provide enhanced insights into real-world interactions.

Such an approach may achieve improved behavioral replication by creating a digital twin of human behavior with fidelity and holistic human understanding by combining physical, cognitive, and/or emotional data for behavioral insights. Moreover, predictive human behavior modeling may enable accurate forecasts of human responses and decisions, while immersive data exploration may let analysts “step inside” the data for intuitive understanding. Cross-reality insights may bridge the gap between virtual and physical world behaviors, and micro-interaction analysis may capture and analyze subtle behaviors invisible to traditional methods. Moreover, contextual intelligence may understand human behavior in relation to environmental and situational factors, while personalized intervention design enables tailored strategies for behavior change or optimization. In some embodiments, collective behavior mapping may aggregate individual extended reality data for population-level insights.

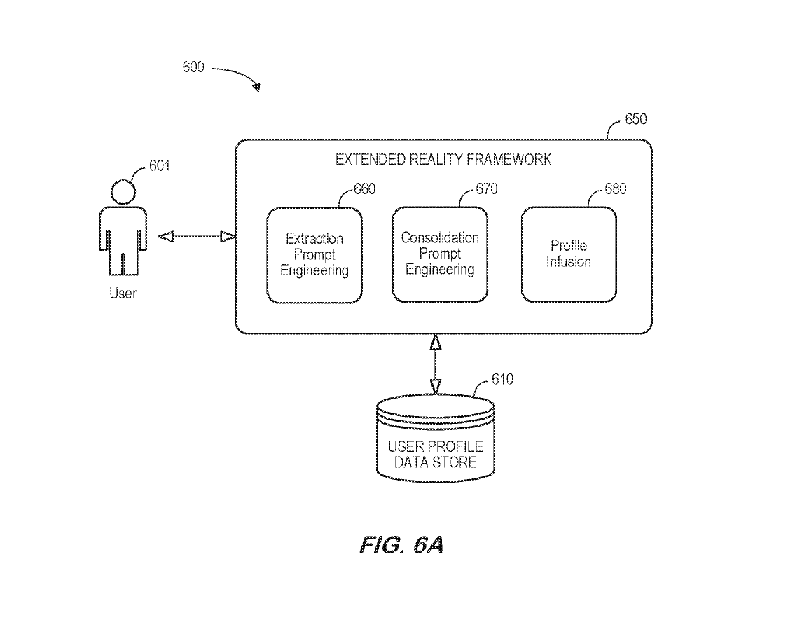

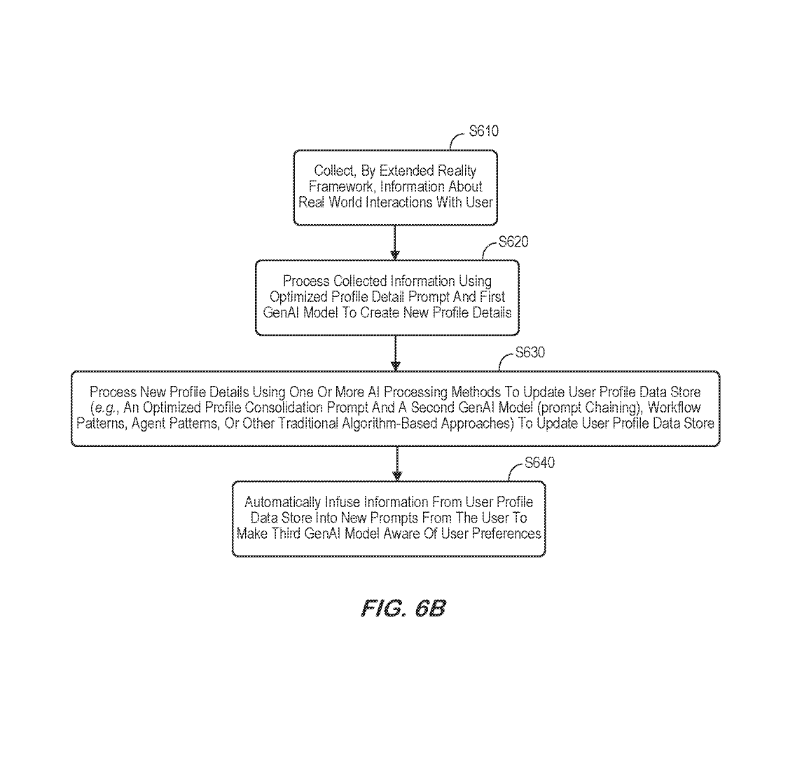

FIGS. 6A and 6B show a system 600 and method according to one embodiment. In particular, FIG. 6A shows a system 600 to provide GenAI interaction-based extraction and refinement of a user profile. An extended reality framework 650 may exchange information associated with extended reality with a user profile data store 610. The extended reality framework 650 may use extraction prompt engineering 660, consolidation prompt engineering 670, and/or profile infusion 680 to create or modify an immersive experience in response to a request from a user 601. FIG. 6B illustrates a method according to this embodiment. At S610, information about real-world interactions with a user is collected and processed using an optimized profile detail prompt and a first GenAI model to create new profile details at S620. At 630, the new profile details are processed using one or more AI processing methods to update a user profile data store. The AI processing methods might include, for example, an optimized profile consolidation prompt and a second GenAI model (prompt chaining), workflow patterns (e.g., orchestrator-worker, evaluator-optimizer, router, etc.), agent patterns (e.g., network, hierarchical, etc.), or other traditional algorithm-based approaches. The system may then automatically infuse information from the user profile data store into new prompts from the user to make another GenAI model aware of user preferences at S640.

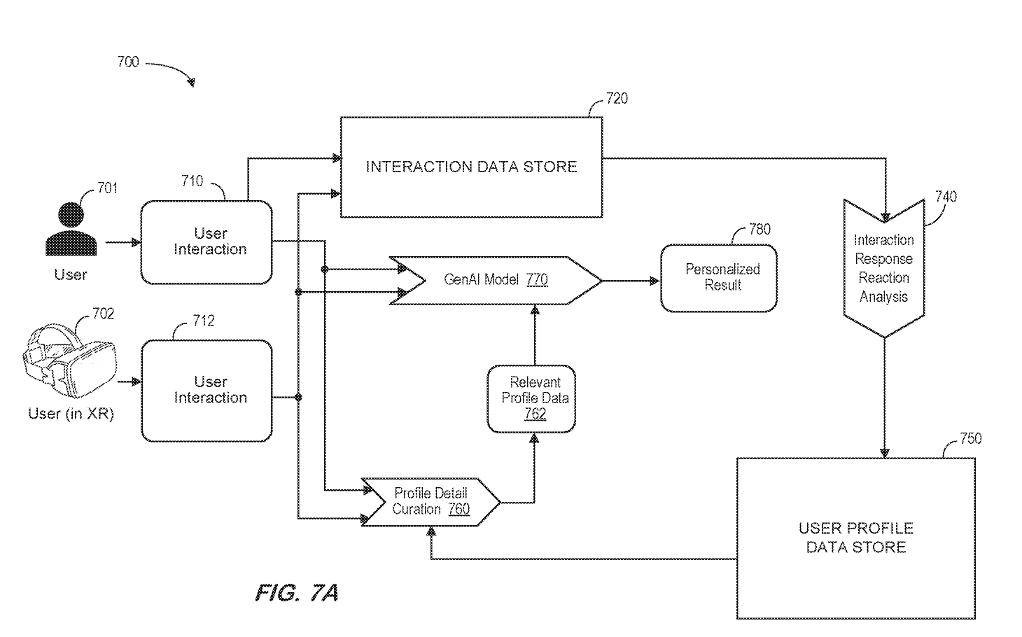

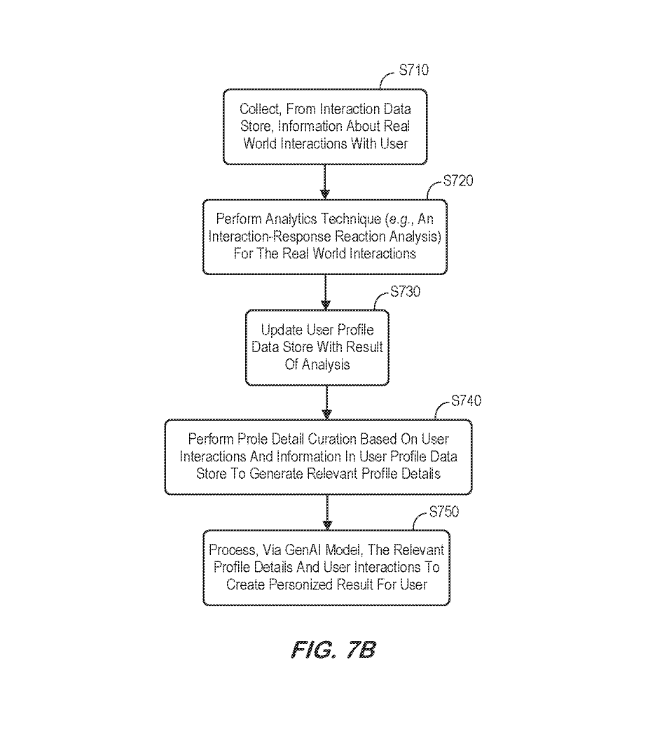

FIGS. 7A and 7B show a system 700 and method in accordance with another embodiment. In particular, FIG. 7A shows a system 700 to provide GenAI interaction-based extraction and refinement of a user profile. In this embodiment, users 701, 702 perform user interactions 710, 720 that are stored in an interaction data store 720. Note that user 702 might be the same person as user 701 or another person working in a similar role or department, etc. Interaction response reaction analysis 740 can then update a user profile data store 750 such that relevant profile data 762 can be created by profile detail curation 760. A GenAI model 770 can then use the relevant profile data 762 along with user interactions 710, 712 and output a personalized result 780. FIG. 7B illustrates a method according to this embodiment. At S710, information about real-world interactions with a user is collected. At S720, the system performs an analytic technique (e.g., an interaction response analysis) for the real-world interactions, and a user profile data store is updated with results of the analysis at S730. At S740, profile detail curation is performed based on user interactions and information in the user profile data store to generate relevant profile details. The system can then process, via a GenAI model, the relevant profile details and user interactions to create a personized result for the user at S750.

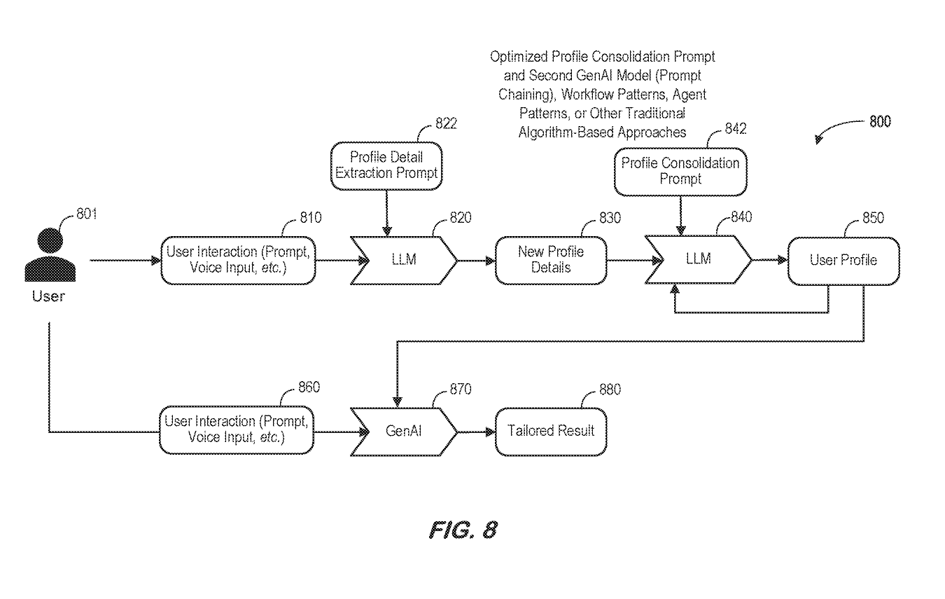

FIG. 8 is a more detailed version 800 of the system 600 of FIG. 6A according to some embodiments. A user 801 provides a user interaction that is analyzed by a first LLM 820 (using a profile detail extraction prompt 822 created via “prompt engineering”) to generate new profile details 830. As used herein, the phrase “prompt engineering” may refer to any process to develop and optimize prompts to efficiently use LLMs for a wide variety of applications and research topics. Prompt engineering can be used to improve the capacity of LLMs on a wide range of common and complex tasks such as question answering. Developers use prompt engineering to design robust and effective prompting techniques that interface with LLMs. The new profile details 830 are analyzed by a second LLM 840 (using a profile consolidation prompt 822 created via prompt engineering) to update a user profile 850. When the user 801 provides another user interaction 860, a GenAI model 870 can then access the user profile 850 to create a tailored result 880 for the user 801.

In this way, embodiments may avoid inefficient and inconsistent customization of GenAI models by an interaction-based extraction and refinement system for the user profile 850. This version 800 is designed to analyze each user interaction 810 or prompt for personal preferences and details that can enhance the accuracy of the user profile 850. Special emphasis may be placed on user 801 feedback, particularly in consecutive chat settings where the user 801 can respond to the model output.

Two optimized prompts 822, 842 may be crafted through prompt engineering. The first prompt 822 is designed to receive user interactions 810 and extract profile details. The second prompt 842 is designed to combine these new details with the existing user profile 850. Note that embodiments may also use, instead of or in addition to prompt chaining, workflow patterns, agent patterns, and/or other traditional algorithm-based approaches. This process results in a central store of user profile 850 details that is continuously updated with more accurate and extensive information. The version 800 may be designed to avoid redundancies and maintain a high level of compression.

This central user profile 850 can then be automatically infused into new prompts to make the GenAI model 870 aware of user 801 preferences. This allows the GenAI model 870 to adapt to both general and use-case specific preferences, providing a more personalized and consistent user experience across different sessions and use cases. This interaction-based extraction and refinement system thus provides an efficient and consistent way to customize and refine the output the GenAI model 870.

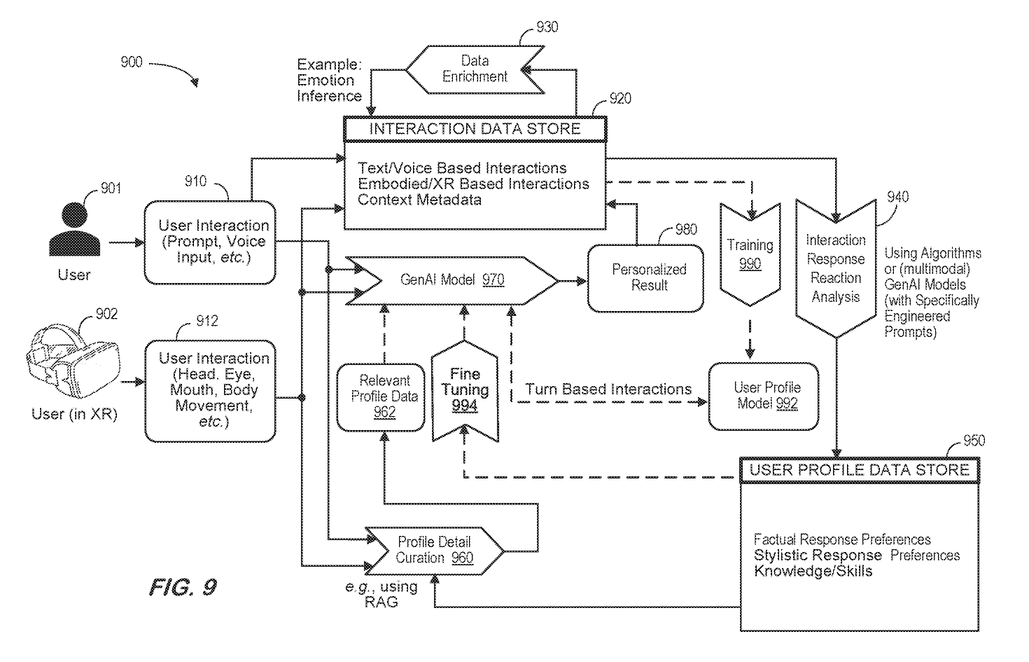

FIG. 9 is a more detailed version 900 of the system 700 of FIG. 7A in accordance with some embodiments. A user 901 may perform interactions 910, and that information can be stored in an interaction data store 920 and be periodically enriched 930. Information in the interaction data store 920 may undergo interaction response reaction analysis 940, and the results may be stored in a user profile data store 950. The information in the user profile data store 950 can then be used (along with interaction data) for profile detail curation 960 to create relevant profile data 962. A GenAI model 870 uses the relevant profile data 962 to create a personalized result 980 when a user 902 provides another user interaction 912. In some embodiments, output from a trained 990 user profile model 992 is also provided to the GenAI model 970 (e.g., in turn-based interactions) along with fine tuning information 994 from the user profile data store 950.

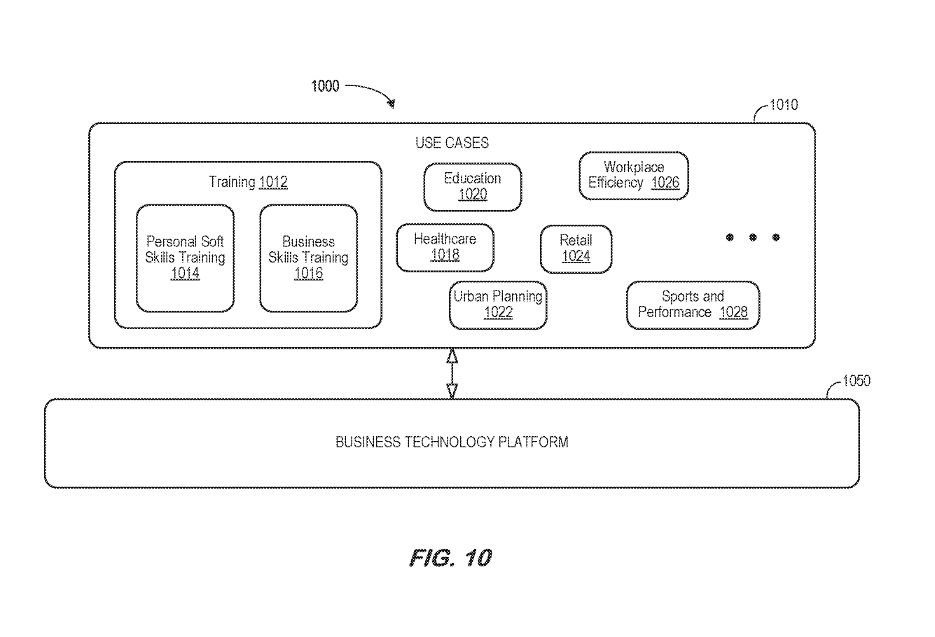

FIG. 10 is an illustration 1000 of some examples of use cases 1010 according to some embodiments. The use cases 1010 may interact with a business technology platform 1050 to extend and personalize applications, integrate and connect landscapes, and/or unleash business users to connect processes and experiences, make decisions with confidence, and drive business innovation. The use cases 1010 might be associated with, for example, training 1012 and entertainment (e.g., to create movies or video games), etc. The training 1012 might include, for example, personal soft skills training 1014 (e.g., becoming comfortable with public speaking, learning a new hobby, creating a video message for a special occasion, etc.) and/or business skills training 1016 (e.g., sales simulation, learning programming, improving decision making, talking with employees, learning a new role, an enterprise employee onboarding process, etc.). Other use cases include healthcare 1018 (e.g., detailed patient behavior analysis rehabilitation progress tracking), education 1020 (e.g., personalized learning path optimization, cognitive development mapping), urban planning 1022 (e.g., human-centric design based on aggregate movement and interaction patterns), retail 1024 (e.g., advanced customer journey mapping in physical and virtual stores), workplace efficiency 1026 (e.g., ergonomic analysis and workflow optimization), sports and performance 1028 (e.g., micro-movement analysis for athletic training), etc.

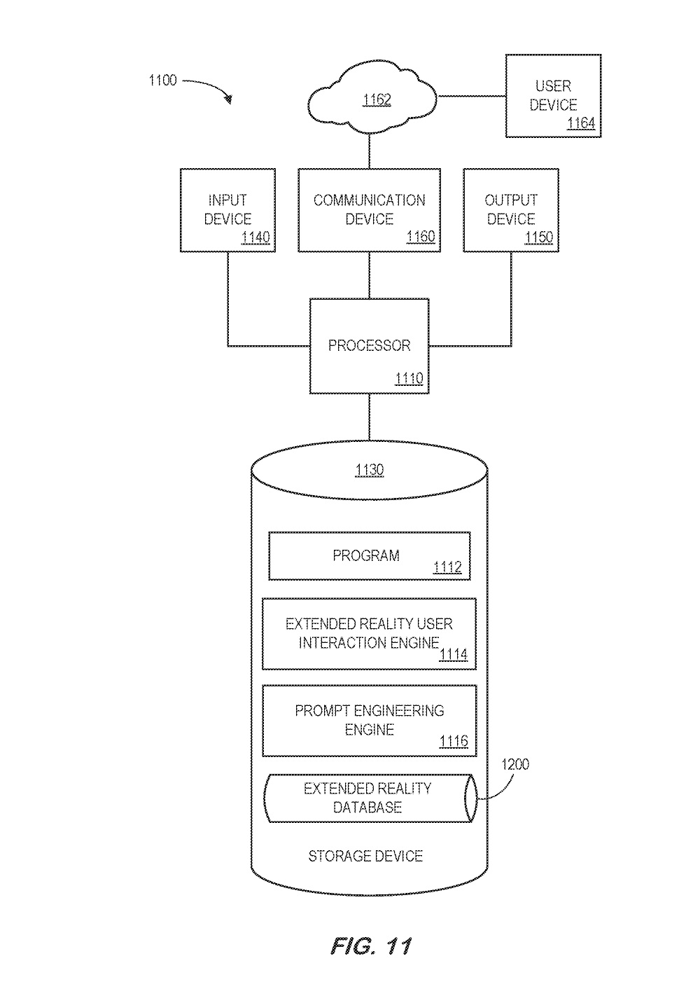

Note that the embodiments described herein may be implemented using any number of different hardware configurations. For example, FIG. 11 is a block diagram of an apparatus or platform 1100 that may be, for example, associated with the architecture 100 of FIG. 1 (and/or any other system described herein). The platform 1100 comprises a processor 1110, such as one or more commercially available Central Processing Units (“CPUs”) in the form of one-chip microprocessors, coupled to a communication device 1160 configured to communicate via a communication network 1162. The communication device 1160 may be used to communicate, for example, with one or more user devices 1164 via a distributed computer network 1162. The platform 1100 further includes an input device 1140 (e.g., a computer mouse and/or keyboard to input user interactions, prompts, etc.) and/an output device 1150 (e.g., a computer monitor to render a display, transmit recommendations, charts, alerts, and/or extended reality environments, etc.).

The processor 1110 also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1112, extended reality user interaction engine 1114, and/or prompt engineering engine 1116 for controlling the processor 1110. The processor 1110 performs instructions of the programs 1112, 1114, 1116 and thereby operates in accordance with any of the embodiments described herein. For example, the processor 1110 may collect information about real-world interactions with the user and integrate that information with real-world environment data. The processor 1110 may then process the real-world interactions and real-world environment data using multi-modal data fusion techniques, real time data enrichment, and contextual data mapping to link the real-world interactions with a real-world scenario. Augmented analytics are performed by the processor 1110 to generate enhanced insights about the user. An immersive extended reality visualization can then be created based on the enhanced insights. According to some embodiments, at least some of the augmented analytics are done by a set of LLM agents that work together.

As another example, the processor 1110 may collect information about real-world interactions with a user. The collected information is processed using an optimized profile detail prompt and a first GenAI model to create new profile details. The new profile details are then processed using one or more AI processing methods to update a user profile data store. The AI processing methods might include, for example, an optimized profile consolidation prompt and a second GenAI model (prompt chaining), workflow patterns, agent patterns, and/or other traditional algorithm-based approaches. The processor 1110 can then automatically infuse information in the user profile data store into new prompts from the user to make another GenAI model aware of user preferences.

As still another example, the processor 1110 may collect information about real-world interactions with a user. The processor 1110 then performs an analytical technique for the real-world interactions and updates the user profile data store with a result of the analysis. The processor 1110 may then perform profile detail curation based on user interactions and information in the user profile data store to generate relevant profile details. A GenAI model processes the relevant profile details and user interactions to create a personized result for the user.

The programs 1112, 1114, 1116 may be stored in a compressed, uncompiled and/or encrypted format. The programs 1112, 1114, 1116 may furthermore include other program elements, such as an operating system, clipboard application, a database management system, and/or device drivers used by the processor 1110 to interface with peripheral devices.

As used herein, information may be “received” by or “transmitted” to, for example: (i) the platform 1100 from another device; or (ii) a software application or module within the platform 1100 from another software application, module, or any other source.

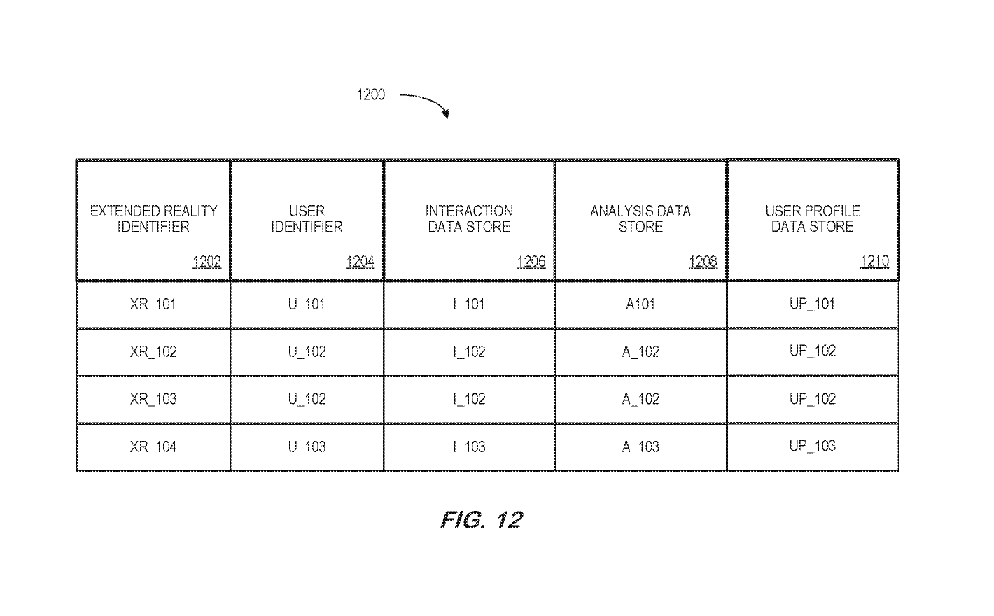

In some embodiments (such as the one shown in FIG. 11), the storage device 1130 further stores an extended reality database 1200. An example of a database that may be used in connection with the platform 1100 will now be described in detail with respect to FIG. 12. Note that the database described herein is only one example, and additional and/or different information may be stored therein. Moreover, various databases might be split or combined in accordance with any of the embodiments described herein.

Referring to FIG. 12, a table is shown that represents the extended reality database 1200 that may be stored at the platform 1100 according to some embodiments. The table may include, for example, entries identifying scenes that may be experienced. The table may also define fields 1202, 1204, 1206, 1208, 1210 for each of the entries. The fields 1202, 1204, 1206, 1208, 1210 may, according to some embodiments, specify: an extended reality identifier 1202, a user identifier 1204, an interaction data store 1206, an analysis data store 1208, and a user profile data store 1210. The extended reality database 1200 may be created and updated, for example, when a user interacts with locations, provides prompts about preferences, etc.

The extended reality identifier 1202 might be a unique alphanumeric label that is associated with an interactive, immersive experience. The user identifier 1204 may show who is interacting with the location. The interaction data store 1206 may point to a database that contains information about extended reality interactions with the user. The analysis data store 1208 may point to a database that stores results of a data analysis performed on information in the interaction data store 1206. The user profile data store 1210 may point to a database that stores results of an interaction response reaction analysis performed on information in the interaction data store 1206.

In this way, embodiments may leverage extended reality technology to create an accurate digital twin of human behavior and interactions. The extended reality derived data analytics may be applied across multiple domains and combined with other data sources for enhanced insights. Moreover, ethical AI training may provide rich, diverse data for training AI models on human behavior, and enhanced accessibility analysis may offer detailed insights into how different individuals interact with environments. In some embodiments, cognitive load optimization helps design interfaces and experiences that minimize mental strain, and cultural and societal insights allow for a comparative analysis of behaviors across different groups and cultures. According to some embodiments, accelerated research capabilities enable rapid, large-scale behavioral studies in controlled extended reality environments, and an adaptive system design facilitates the creation of systems that dynamically adjust to individual user behaviors.

Embodiments reduce the amount of manual labor required for fine-tuning GenAI model outputs. By using an interaction-based extraction and refinement system, embodiments may automate the process of capturing and applying user preferences, reducing the need for manual definition of these preferences. This may result in an exponential decrease in the time and effort required for customization, leading to increased efficiency and productivity. Moreover, by continuously updating a central store of profile details with information extracted from user interactions, a GenAI model creates tailored results adapted to general and/or use-case specific preferences. This results in outputs that are personalized and consistent with the user’s preferences (enhancing the user experience).

Further, some embodiments may improve GenAI model output consistency across different sessions and use cases. By maintaining a central store of profile details, user preferences can be persisted across sessions (leading to more consistent outputs). In addition, embodiments may enhance the adaptability of a GenAI model. By infusing a central user profile into new prompts, the GenAI model can adapt to a wide range of user preferences (making the model more versatile and flexible).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of use cases, any of the embodiments described herein could be applied to other types of use cases.

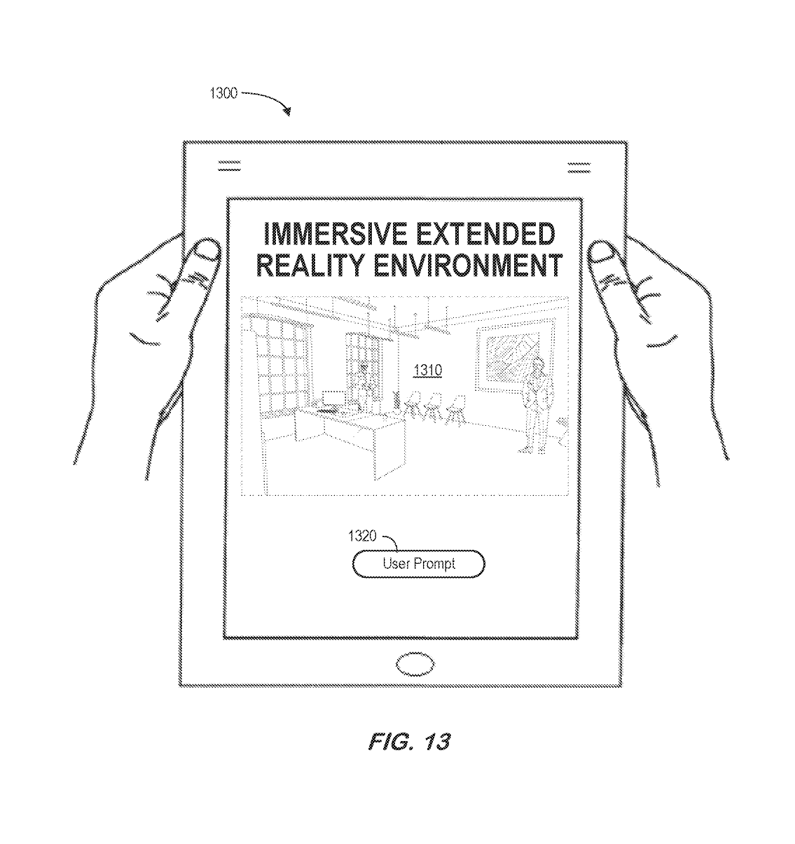

In addition, the displays shown herein are provided only as examples, and any other type of user interface could be implemented. For example, FIG. 13 illustrates a tablet computer 1300 providing an extended reality display 1310 according to some embodiments. The extended reality display 1310 might be used, for example, to train employees about new safety guidelines being implemented by an enterprise. A user may interact with the display 1310, such as by selecting a “User Prompt” text entry area 1320.

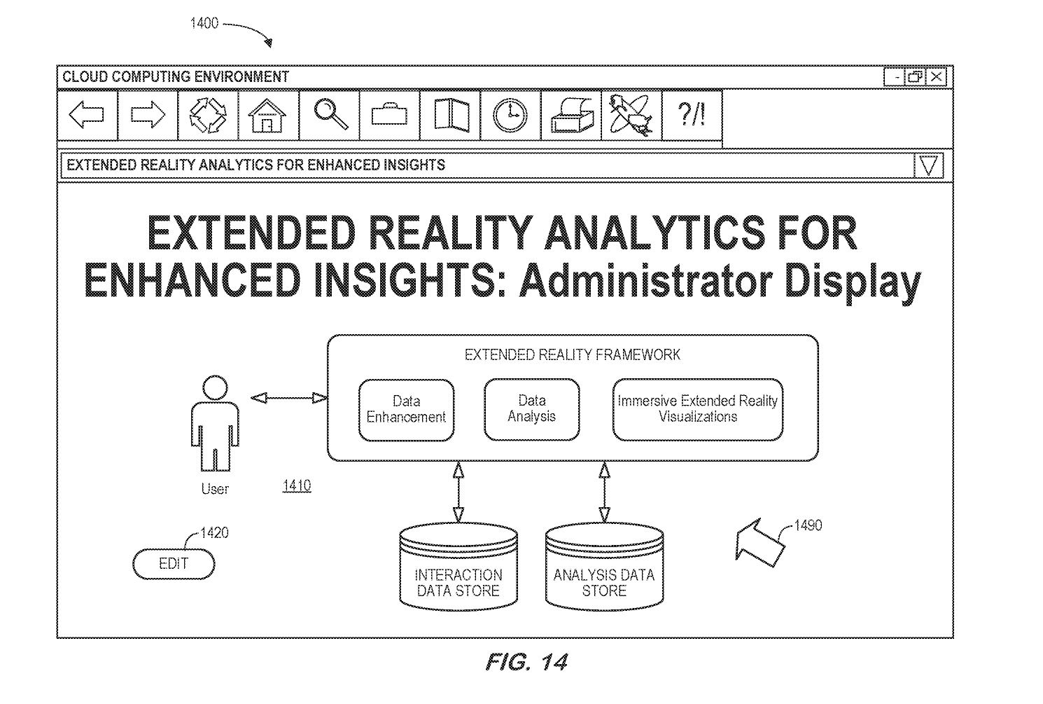

FIG. 14 is an operator or administrator display in accordance with some embodiments. The display 1400 includes a graphical representation 1410 of an extended reality framework in accordance with any of the embodiments described herein. Selection of an element on the display 1400 (e.g., via a touchscreen or computer pointer 1490) may result in display of a pop-up window containing more detailed information about that element and/or various options (e.g., to define how an extended reality framework interacts with various data stores, user devices, external resources, etc.). Selection of an “Edit” icon 1420 may also let an operator or administrator adjust the operation of the system (e.g., to change mapping to a data store, adjust user preference rules, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system, comprising:
a user profile data store that contains electronic records to represent user preference information associated with a user, and
an extended reality framework coupled to the user profile data store, including:
a computer processor, and
a computer memory storing instructions that when executed by the computer processor cause the extended reality framework to:
collect information about real world interactions with a user,
process the collected information using an optimized profile detail prompt and a first Generative Artificial Intelligence (“GenAI”) model to create new profile details,
process the new profile details using one or more AI processing methods to update the user profile data store, and
automatically infuse information from the user profile data store into new prompts from the user to make another GenAI model aware of user preferences.

2. The system of claim 1, wherein the one or more AI processing methods used to update the user profile data store include at least one of: (i) an optimized profile consolidation prompt and a second GenAI model, (ii) prompt chaining, (iii) workflow patterns, (iv) agent patterns, and (v) other traditional algorithm-based approaches.

3. The system of claim 1, wherein the other GenAI model is aware of user preferences on a use case specific basis.

4. The system of claim 3, wherein the user preferences are associated with at least one of: (i) a factual preference, (ii) an answer length preference, (iii) a genre preference, and (iv) a style preference.

5. The system of claim 1, wherein the other GenAI model is aware of user preferences on a general basis.

6. The system of claim 5, wherein the user preferences are associated with at least one of: (i) a language preference, (ii) an accessibility preference, (iii) an emotional preference, (iv) a knowledge level, and (v) a skill level.

7. The system of claim 1, wherein ethical AI training provides training AI models on human behavior, and enhanced accessibility analysis offers detailed insights into how different individuals interact with environments.

8. A system, comprising:
an interaction data store that contains electronic records to represent real world interaction data associated with a user;
a user profile data store that contains insights about the user; and
an extended reality framework coupled to the interaction data store and the analysis data store, including:
a computer processor, and
a computer memory storing instructions that when executed by the computer processor cause the extended reality framework to:
collect, from the interaction data store, information about real world interactions with the user,
perform an analytical technique for the real-world interactions,
update the user profile data store with a result of the analysis,
perform profile detail curation based on user interactions and information in the user profile data store to generate relevant profile details, and
process, via a Generative Artificial Intelligence (“GenAI”) model, the relevant profile details and user interactions to create a personized result for the user.

9. The system of claim 8, wherein the analytical technique is an interaction-response analysis.

10. The system of claim 8, wherein information in the interaction data store includes at least one of: (i) behavioral patterns, (ii) cognitive maps, predictive models, (iii) social network graphs, (iv) time series data, (v) anomaly reports, (vi) performance metrics, (vii) comparative analytics, (viii) text/voice interactions, (ix) embodied/extended reality interactions, and (x) context metadata.

11. The system of claim 10, wherein information in the interaction data store is enhanced via at least one of: (i) multimodal data fusion, (ii) cognitive load estimation, and (iii) emotion inference.

12. The system of claim 11, wherein information in the interaction data store includes at least one of: (i) structured data, (ii) unstructured data, and (iii) raw, high-volume extended reality data from a data lake.

13. The system of claim 8, wherein the GenAI is associated with at least one of: (i) a Large Language Model (“LLM”), and (ii) a set of AI agents that work together.

14. The system of claim 8, wherein the extended reality framework is associated with at least one of: (i) Augmented Reality (“AR”), (ii) Virtual Reality (“VR”), and (iii) Mixed Reality (“MR”).

15. The system of claim 8, wherein the collection of information about real world interactions with the user includes at least one of: (i) prompt information, (ii) voice input, (iii) head movement, (iv) eye movement, (v) mouth movement, and (vi) body movement.

16. The system of claim 8, wherein information in the interaction data store is used to train a user profile model provided to the GenAI model along with turn-based interactions.

17. The system of claim 8, wherein the analytical technique is performed using at least one of: (i) algorithms, and (ii) GenAI models with specifically generated prompts.

18. The system of claim 8, wherein the profile detail curation is performed using Retrieval-Augmented Generation (“RAG”).

19. The system of claim 8, wherein the extended reality framework is associated with at least one of the following application domains: (i) healthcare, (ii) education, (iii) urban planning, (iv) retail, (v) workplace efficiency, and (vi) sports and performance.

20. A computer-implemented method, comprising:
collecting, by an extended reality framework computer processor, information about real world interactions with a user;
processing the collected information using an optimized profile detail prompt and a first Generative Artificial Intelligence (“GenAI”) model to create new profile details; and
processing the new profile details using one or more AI processing methods to update a user profile data store that contains electronic records to represent user preference information associated with a user; and
automatically infusing information in the user profile data store into new prompts from the user to make another GenAI model aware of user preferences.

21. The method of claim 20, wherein the one or more AI processing methods used to update the user profile data store include at least one of: (i) an optimized profile consolidation prompt and a second GenAI model, (ii) prompt chaining, (iii) workflow patterns, (iv) agent patterns, and (v) other traditional algorithm-based approaches.

22. The method of claim 20, wherein the other GenAI model is aware of user preferences on a use case specific basis and the user preferences are associated with at least one of: (i) a factual preference, (ii) an answer length preference, (iii) a genre preference, and (iv) a style preference.

23. The method of claim 20, wherein the other GenAI model is aware of user preferences on a general basis and the user preferences are associated with at least one of: (i) a language preference, (ii) an accessibility preference, (iii) an emotional preference, (iv) a knowledge level, and (v) a skill level.

24. The method of claim 20, wherein at least one of the GenAI are associated with at least one of: (i) a Large Language Model (“LLM”), and (ii) a set of AI agents that work together.
